(19) United States
(12) Patent Application Publication
(10) Pub. No.: US 2004/0047073 A1
(43) Pub. Date: Mar. 11, 2004

(54) Thin-film magnetic head with inductive write head element

(75) Inventors: Tamon Kasajima, Kwai Chung (HK); Masashi Shiraishi, Kwai Chung (HK)

Correspondence Address: BURNS DOANE SWECKER & MATHIS L L P, POST OFFICE BOX 1404, ALEXANDRIA, VA, 22313-1404, US

(73) Assignee: SAE MAGNETICS (H.K.) LTD.

(21) Appl. No.: 10/649,786

(22) Filed: Aug. 28, 2003

(30) Foreign Application Priority Data
Aug. 28, 2002 (JP) 248575/2002

(51) Int. Cl. G11B 5/147

(52) U.S. Cl. 360/126

(57) ABSTRACT

A thin-film magnetic head includes an insulation gap, first and second magnetic poles separated with each other by the insulation gap, a yoke magnetically connected to the first and second magnetic poles, at least one coil conductor wound around the yoke by a plurality of turns, and at least one metal layer arranged near the at least one coil conductor in parallel with a plane of the at least one coil conductor.

### FIELD OF THE INVENTION

The present invention relates to a thin-film magnetic head element provided with an inductive write head element.

### DESCRIPTION OF THE RELATED ART

Such thin-film magnetic head has a coil wound around a yoke that is magnetically coupled with two magnetic poles separated with each other by a recording gap and performs write operation of magnetic information by flowing a write current through the coil.

The write current applied to the coil is in general rectangular wave shape pulses. Wave shape and magnitude of current actually flowing through the coil when the rectangular wave shape pulses are applied vary depending upon structure of the thin-film magnetic head, upon an output impedance of a current source connected with the coil, and upon a frequency and a voltage of the applied rectangular wave pulses. These are affected also by a characteristic impedance of trace conductors and connection lines between the current source and the magnetic head. Particularly, in case that the influence of the trace conductor is eliminated by fixing the frequency and the current of the applied pulses, this variation in the wave shape of current is caused by non-linearity of the input impedance of the coil.

If the wave shape of current flowing through the inductive write head element of the thin-film magnetic head is deformed, magnetic pattern written in a magnetic medium will become distorted and thus write and read operations of data will become difficult. Also, in order to improve the nonlinear transition shift (NLTS) in dynamic characteristics, it is necessary to shorten a rising time of the wave shape of current flowing through the coil.

Therefore, required for the wave shape of current flowing through the coil are (1) to maintain a profile of the rectangular wave shape pulses provided from the current source as much as possible, (2) to have a short rising time, and (3) to have a high current value with holding the rectangular wave shape in order to obtain a strong write magnetic field.

These requirements (1)-(3) may be satisfied by decreasing the coil inductance at the frequency of the write current. However, if the number of turns of the coil is reduced to decrease the inductance, magnetic force generated from the coil will decrease causing no improvement of the characteristics. Also, if the size of the coil is reduced by narrowing a coil pitch, difficulty in fabrication of the coil and problems of heating may occur.

### SUMMARY OF THE INVENTION

It is therefore an object of the present invention to provide a thin-film magnetic head, whereby an inductance of a coil conductor can be reduced with keeping a shape and a size of the coil conductor as much as possible.

According to the present invention, a thin-film magnetic head includes an insulation gap, first and second magnetic poles separated with each other by the insulation gap, a yoke magnetically connected to the first and second magnetic poles, at least one coil conductor wound around the yoke by a plurality of turns, and at least one metal layer arranged near the at least one coil conductor in parallel with a plane of the at least one coil conductor.

The first and second metal layers are arranged near and in parallel with the plane of the coil conductor. Therefore, with keeping a shape and size of the coil conductor, the inductance thereof can be lowered, that is, the peak of the input impedance of the coil conductor can be shifted to the higher frequency side. As a result, it is possible to flow a write current having a short rising time and a high current value through the coil conductor with maintaining a profile of rectangular wave shape input pulses as much as possible. Due to the short rising time, correct writing operations can be expected even if the write frequency is high as 300 MHz for example. Because the characteristic impedance of trace conductors electrically connected to the coil conductor can be lowered by the corresponding amount of the reduced input impedance of the coil conductor, the width of the trace conductors can be increased to heighten thermal dissipation performance of the trance conductors. In addition, since the metal layer is arranged near the coil conductor, heat generated in the coil conductor can be effectively dissipated.

It is preferred that the at least one metal layer includes a metal layer covering an area within which the at least one coil conductor is formed.

It is also preferred that the head includes trace conductors electrically connected to the at least one coil conductor, and that the at least one metal layer comprises a metal layer covering an area within which the at least one coil conductor and the trace conductors are formed.

It is further preferred that the at least one metal layer is not grounded or grounded.

It is preferred that the at least one metal layer consists of a single metal layer arranged at one side of the at least one coil conductor, or a plurality of metal layers arranged at both sides of the at least one coil conductor.

It is also preferred that the head includes trace conductors electrically connected to the at least one coil conductor, and that the trace conductors are arranged so as to not penetrate or penetrate the at least one metal layer.

It is preferred that the at least one coil conductor consists of a single coil conductor.

It is still further preferred that the at least one metal layer includes a metal layer made of a metal material with a high conductivity. If the high conductivity metal material is used, it is possible to more reduce the input impedance of the coil conductor.

Further objects and advantages of the present invention will be apparent from the following description of the preferred embodiments of the invention as illustrated in the accompanying drawings.

### BRIEF DESCRIPTION OF THE DRAWINGS

FIG. 1 shows an exploded oblique view illustrating simple configuration of a coil conductor and metal layers of a thin-film magnetic head as a preferred embodiment according to the present invention;

FIG. 2 shows an exploded oblique view illustrating operations of the embodiment shown in FIG. 1;

FIG. 3 shows an exploded oblique view illustrating operations of the embodiment shown in FIG. 1;

FIG. 4 shows a plane view of the coil conductor of the embodiment shown in FIG. 1;

FIG. 5 shows an exploded side view seen from the direction shown by the arrow illustrated in FIG. 4;

FIG. 6 shows an exploded oblique view schematically illustrating a concrete example of the coil conductor and the metal layers of the thin-film magnetic head of the embodiment shown in FIG. 1;

FIG. 7 shows an exploded side view illustrating operations of the example shown in FIG. 6;

FIG. 8 shows a sectional view illustrating in detail the whole structure of the thin-film magnetic head of the example shown in FIG. 6;

FIG. 9 shows an exploded plane view, a front view and a side view illustrating configuration of a coil conductor and metal layers in a simulation of input impedance characteristics of the coil conductor with respect to its input voltage frequency;

FIG. 10 illustrates the simulation result of input impedance characteristics of the coil conductor with respect to its input voltage frequency;

FIG. 11 shows an exploded oblique view schematically illustrating a coil conductor and metal layers of a thin-film magnetic head as another embodiment according to the present invention;

FIG. 12 shows a sectional view illustrating in detail the whole structure of the thin-film magnetic head of the embodiment shown in FIG. 11;

FIG. 13 shows a sectional view illustrating in detail the whole structure of the thin-film magnetic head in a modification of the embodiment shown in FIG. 11;

FIG. 14 shows an exploded oblique view schematically illustrating a coil conductor and metal layers of a thin-film magnetic head as a further embodiment according to the present invention;

FIG. 15 shows a sectional view illustrating in detail the whole structure of the thin-film magnetic head of the embodiment shown in FIG. 14;

FIG. 16 shows an exploded oblique view illustrating a simple configuration of a coil conductor and metal layers of a thin-film magnetic head as a still further embodiment according to the present invention; and

FIG. 17 shows an exploded oblique view illustrating a simple configuration of a coil conductor and metal layers of a thin-film magnetic head as a further embodiment according to the present invention.

### DESCRIPTION OF THE PREFERRED EMBODIMENTS

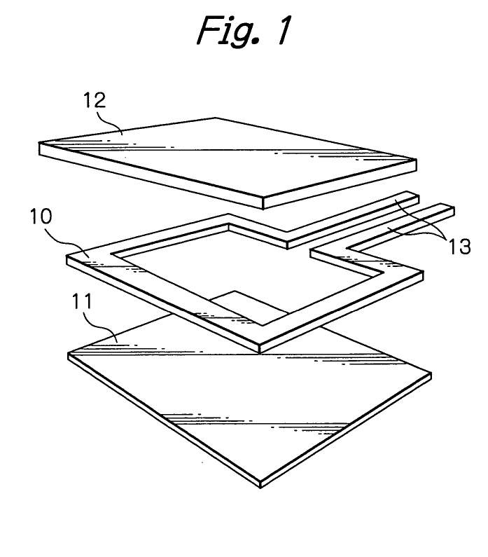

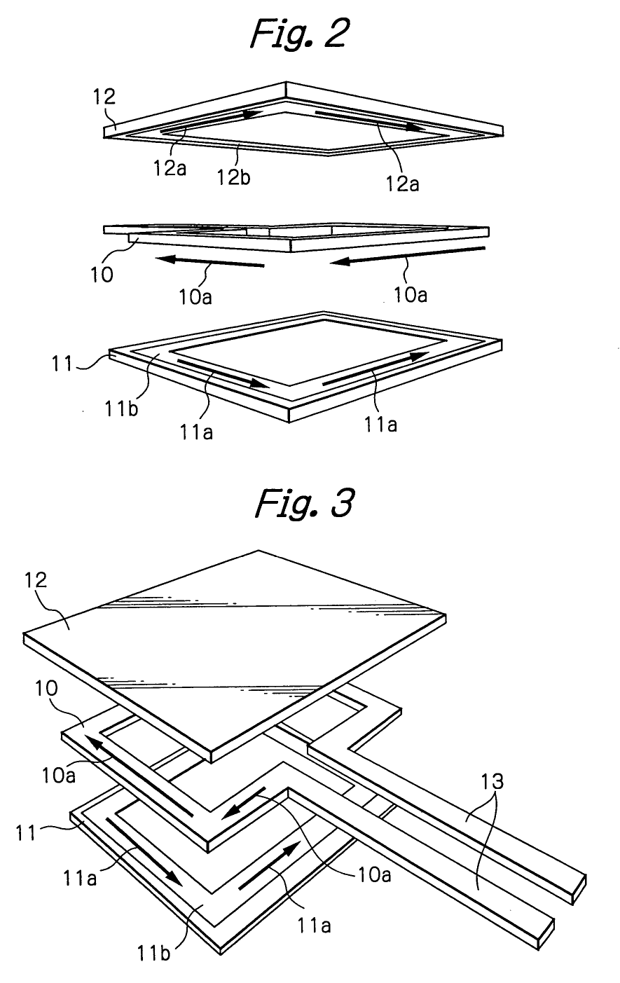

FIG. 1 illustrates simple configuration of a coil conductor and metal layers of a thin-film magnetic head as a preferred embodiment according to the present invention, and FIGS. 2 to 5 illustrate operations of this embodiment.

In these figures, reference numeral 10 denotes the coil conductor in a write head element of the thin-film magnetic head, 11 and 12 denote lower and upper metal layers in a shape of two plates closely located below and above the coil conductor 10 so as to become in parallel with a plane of the coil conductor 10, and 13 denotes trace conductors respectively connected to both ends of the coil conductor 10. In this embodiment, the lower and upper metal layers 11 and 12 are formed within an area where the coil conductor 10 exists to sandwich the conductor 10. The coil conductor 10 and the trace conductors 13 are made of copper for example, and the lower and upper metal layers 11 and 12 are made of a metal material with high electrical conductivity such as copper, gold or silver for example.

As illustrated in FIGS. 2 and 3, if the lower and upper metal plate layers 11 and 12 are arranged in parallel below and above the plane-shaped coil conductor 10 and an alternating current is flowed through the coil conductor 10, electrical fields are induced in the lower and upper metal layers 11 and 12. Due to the induced electrical fields, currents 11a and 12a flow in the respective planes facing toward the conductor 10, of the lower and upper metal layers 11 and 12. The direction of the currents 11a and 12a is opposite to that of the current 10a flowing through the coil conductor 10. These induced currents are particularly strong in regions 11b and 12b of the lower and upper metal layers 11 and 12. Magnetic fields are produced by these induced currents.

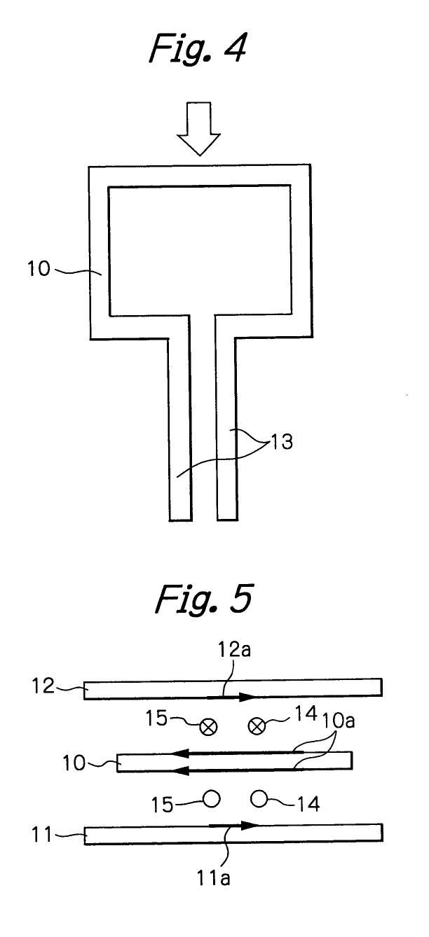

FIG. 4 illustrates the coil conductor 10 of this embodiment, and FIG. 5 illustrates the coil conductor 10 and the metal layers 11 and 12 seen from the direction shown by the arrow in FIG. 4.

As is illustrated in FIG. 5, the current 10a flows in the coil conductor 10 from the right side to the left side in the figure, and thus the currents 11a and 12a flowing through the lower and upper metal layers 11 and 12 from the left side to the right side in the figure are induced, respectively.

Magnetic field 14 is induced due to the current flowing through the coil 10 itself, and also magnetic field 15 is generated by the induced currents flowing through the lower and upper metal layers 11 and 12. As shown in FIG. 5, since the directions of these magnetic fields 14 and 15 are the same, both the magnetic fields 14 and 15 between the lower metal layer 11 and the coil conductor 10 are mutually strengthened and both the magnetic fields 14 and 15 between the coil conductor 10 and the upper metal layer 12 are also mutually strengthened.

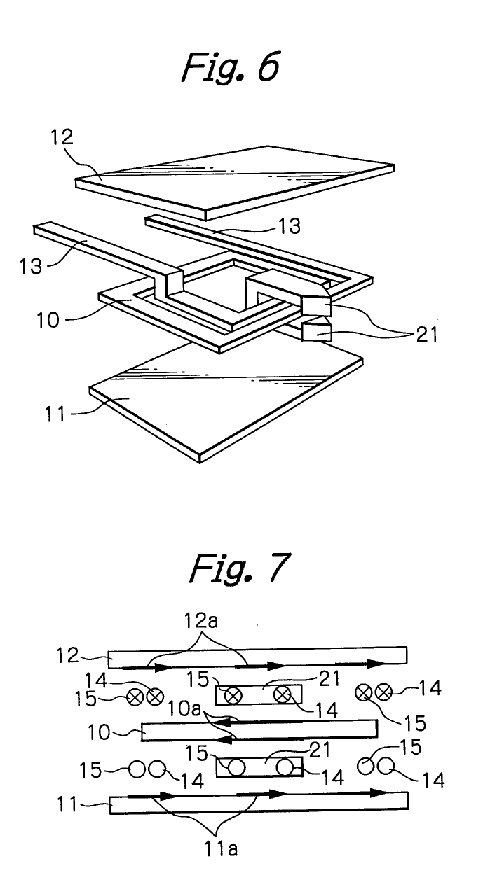

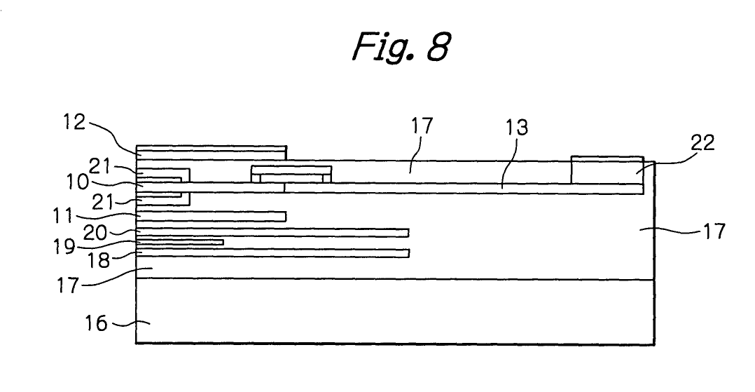

FIG. 6 view schematically illustrates a concrete example of the coil conductor and the metal layers of the thin-film magnetic head of the embodiment shown in FIG. 1, FIG. 7 illustrates operations of this, and FIG. 8 illustrates in detail the whole structure of the thin-film magnetic head of this example.

In these figures, reference numeral 16 denotes a substrate made of Al—TiC for example, 17 denotes an insulation layer made of Al₂O₃ for example, 18 denotes a lower shield layer of a magnetoresistive effect (MR) read head element, 19 denotes an MR layer, 20 denotes an upper shield layer, 21 denotes a yoke made of a ferromagnetic material such as permalloy and provided with at its top ends first and second magnetic poles faced each other via an insulation gap, and 22 denotes a terminal electrode or bump of the coil conductor 10, respectively. The insulation layer around the coil conductor 10 may be made of a resist material instead of Al₂O₃.

The upper shield layer 20 and the yoke 21 are formed independently to separate each other, and the lower metal layer 11 is inserted there between. Due to this structure, it is possible to produce electrical field between the lower metal layer 11 and the coil conductor 10.

The upper metal layer 12 is formed outside of the insulation layer 17 of Al₂O₃ in order to improve thermal dissipation, and a gold layer is formed on the upper surface of the upper metal layer 12. The gold layer is also formed on the upper surface of the terminal electrode 22.

As will be understood from FIG. 7, the magnetic field 14 produced by the current flowing through the coil conductor 10 and the magnetic field 15 produced by the induced currents flowing through the lower and upper metal layers 11 and 12 pass the yoke 21 that is provided in the actual write head element. Since the directions of these magnetic fields 14 and 15 passing through the yoke 21 are the same, both the magnetic fields 14 and 15 are mutually strengthened.

When the frequency of the voltage applied to the coil conductor 10 increases, an input impedance of the coil conductor becomes its peak and no current flows at a certain frequency. The currents flowing through the lower and upper metal layers 11 and 12 however operate to retard this phenomenon. Thus, if the lower and upper metal layers 11 and 12 are additionally formed, it is possible to reduce the frequency of the peak input impedance and its peak value itself.

The shorter of the distance between the coil conductor 10 and the lower or upper metal layer 11 or 12, the stronger of the electrical field induced to increase the current flowing through the metal layer 11 or 12 and thus to enhance the above-mentioned advantages. Therefore, it is desired that the spacing between the coil conductor 10 and the lower metal layer 11 and the spacing between the coil conductor 10 and the upper metal layer 12 are 30 μm or less.

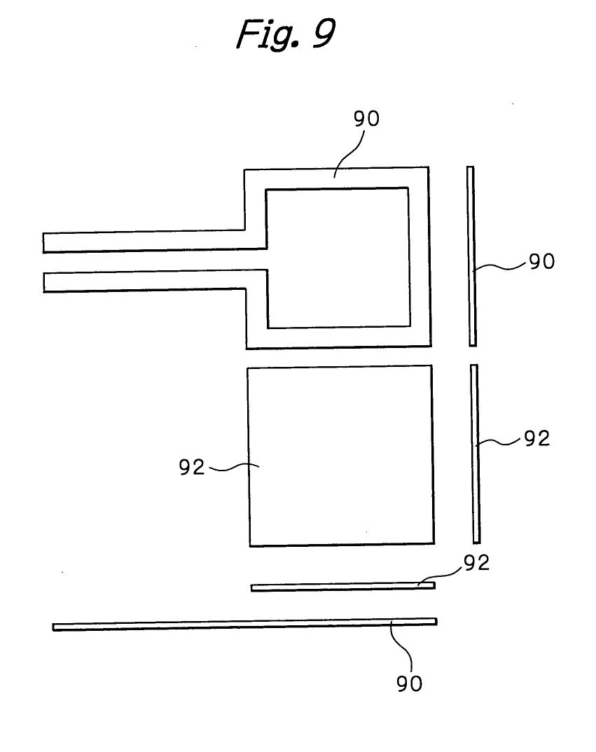

In order to confirm advantages of additionally providing a metal layer in parallel with a coil conductor and to know a desired spacing between the coil conductor and the metal layer, input impedance versus input voltage frequency characteristics of the coil conductor is simulated. The simulated model has a structure with a coil conductor 90 and a single metal layer 92 as shown in FIG. 9. The coil conductor 90 is constituted by winding one turn a strip shaped copper coil with a thickness of 5 μm and a width of 20 μm in a square shape with a side of 190 μm. The metal layer 92 is constituted from a square shaped copper plate with a side of 190 μm and a thickness of 5 μm.

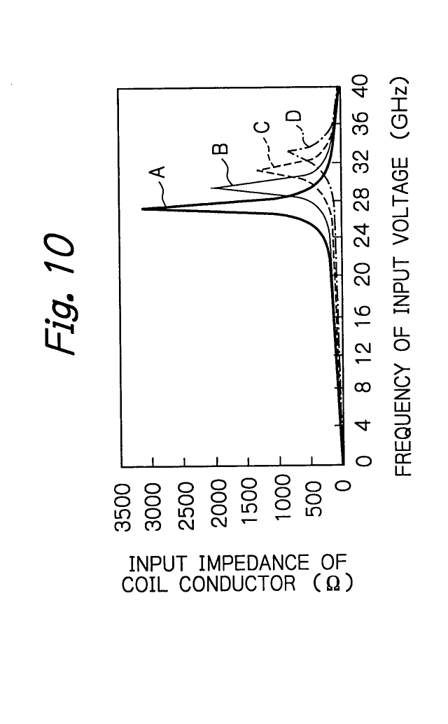

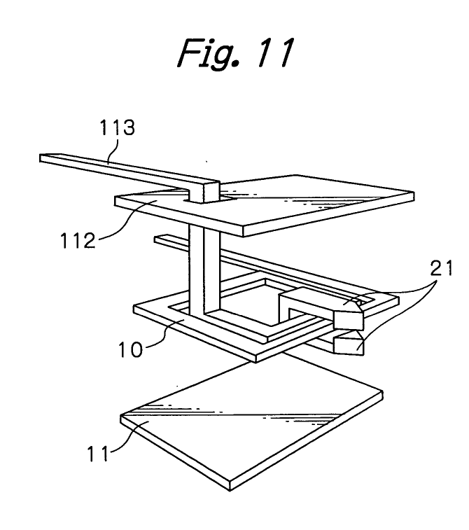

The result of this simulation is shown in FIG. 10. In the figure, A is a model having only a coil conductor 90 namely with no metal layer, B is a model having a coil conductor 90 and a metal layer 92 separated by 20 μm from the coil conductor 90, C is a model having a soil conductor 90 and a metal layer 92 separated by 10 μm from the coil conductor 90, and D is a model having a soil conductor 90 and a metal layer 92 separated by 5 μm from the coil conductor 90. As is noted from the figure, if the metal layer 92 is added and arranged above and in parallel with the coil conductor 90, a frequency of the peak in the input impedance of the coil conductor shifts to the higher frequency side and also the level of the peak is lowered. Furthermore, if the distance between the coil conductor 90 and the metal layer 92 is shortened from 20 μm, then 10 μm and to 5 μm, the peak frequency is shifted higher and the peak level of the impedance is lowered.

As is described, in this embodiment, the lower and upper metal layers 11 and 12 are arranged to sandwich the coil conductor 10 in parallel with the plane of the coil conductor 10. Therefore, with keeping the shape and size of the coil conductor 10, the inductance thereof can be lowered, that is, the peak of the input impedance of the coil conductor 10 can be shifted to the higher frequency side. As a result, it is possible to flow a write current having a short rising time and a high current value through the coil conductor 10 with maintaining a profile of rectangular wave shape input pulses as much as possible. Due to the short rising time, correct writing operations can be expected even if the write frequency is high as 300 MHz for example. Because the characteristic impedance of trace conductors electrically connected to the coil conductor 10 can be lowered by the corresponding amount of the reduced input impedance of the coil conductor 10, the width of the trace conductors can be increased to heighten thermal dissipation performance of the trance conductors. Further, since the coil conductor 10 is sandwiched by the lower and upper metal layers 11 and 12, heat generated in the coil conductor 10 can be effectively dissipated. Particularly, in this embodiment, because the upper metal layer 12 is arranged out of the insulation layer 17, the thermal dissipation performance can be more improved.

If a material with a higher conductivity is used for the lower metal layer 11 and/or the upper metal layer 12, the input impedance of the coil conductor can be further lowered.

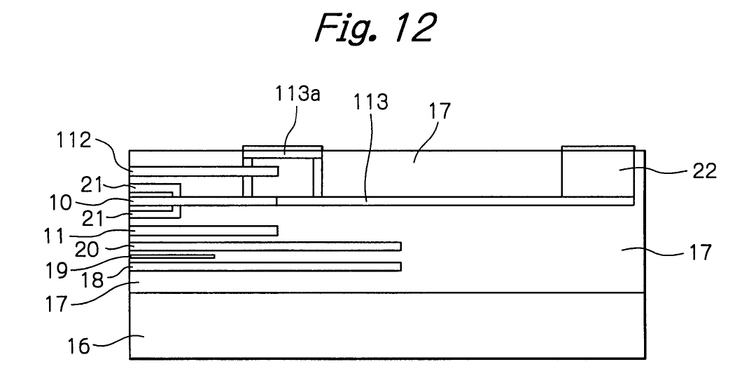

FIG. 11 schematically illustrates a coil conductor and metal layers of a thin-film magnetic head as another embodiment according to the present invention, and FIG. 12 illustrates in detail the whole structure of the thin-film magnetic head of this embodiment.

In this embodiment, one trance conductor 113 electrically connected to one end of the coil conductor 10 penetrates an upper metal layer 112 and a part 113a of the trace conductor 113 is exposed at the upper surface of the insulation layer 17. The upper metal layer 112 is embedded in the insulation layer 17. Another constitution of this embodiment is substantially the same as that of the embodiment of FIG. 1. Therefore, in FIGS. 11 and 12, the same reference numerals are respectively used for the similar elements as these in the embodiment of FIG. 1.

In this embodiment, as is mentioned, the part 113a of the trace conductor 113 is formed at outside of the insulation layer 17 of Al₂O₃ so as to improve the thermal dissipation performance, and a gold layer is formed on the upper surface of the exposed part 113a. This embodiment can certainly provide the same advantages as the embodiment of FIG. 1.

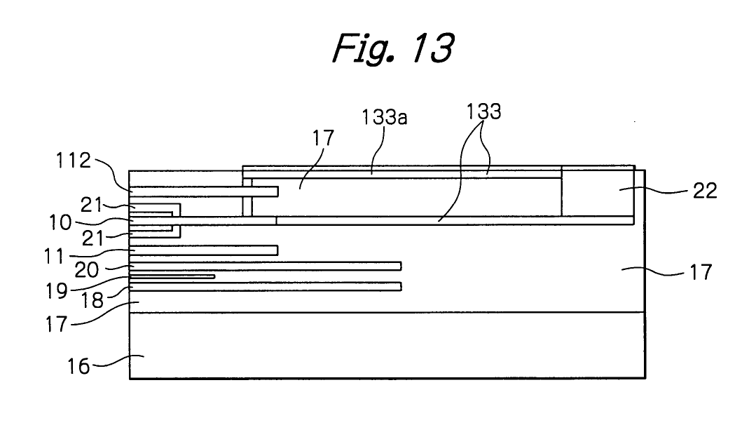

FIG. 13 illustrates in detail the whole structure of a thin-film magnetic head as a modification of the embodiment shown in FIG. 11.

In this modification, one trance conductor 133 electrically connected to one end of the coil conductor 10 penetrates the upper metal layer 112 and a part 133a of the trace conductor 133 is exposed at the upper surface of the insulation layer 17. The exposed part 133a of the trance conductor 133 extends to the terminal electrode 22. Another constitution of this modification is substantially the same as that of the embodiment of FIG. 11. Therefore, in FIG. 13, the same reference numerals are respectively used for the similar elements as these in the embodiment of FIG. 11.

In this modification, as is mentioned, the extended larger part 133a of the trace conductor 133 is formed at outside of the insulation layer 17 of Al₂O₃ so as to more improve the thermal dissipation performance, and a gold layer is formed on the upper surface of the exposed part 133a. This modification can certainly provide the same advantages as the embodiment of FIG. 11.

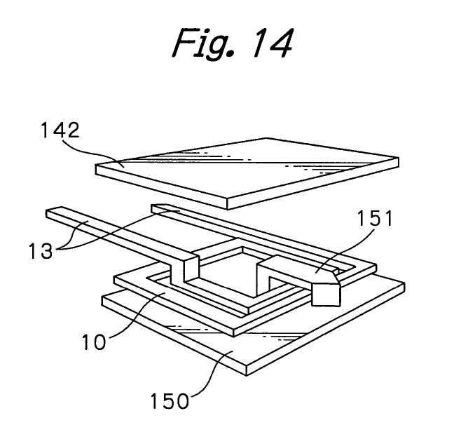

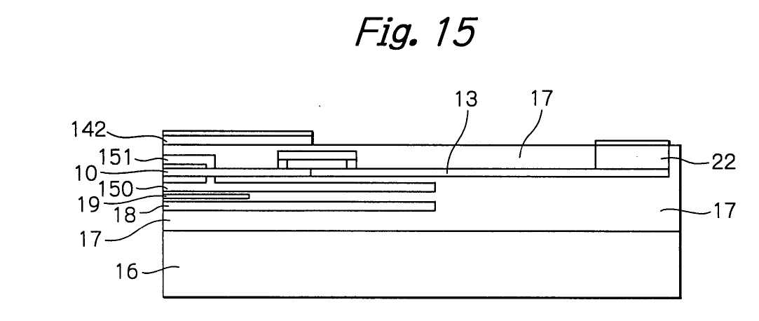

FIG. 14 schematically illustrates a coil conductor and metal layers of a thin-film magnetic head as a further embodiment according to the present invention, and FIG. 15 illustrates in detail the whole structure of the thin-film magnetic head of this embodiment.

In this embodiment, only an upper metal layer 142 is formed above the coil conductor 10 but no lower metal layer is formed under the coil conductor 10. Under the coil conductor 10, an upper shield layer 150 is coupled to a yoke 151 to partially serve as the yoke. Another constitution of this embodiment is substantially the same as that of the embodiment of FIG. 1. Therefore, in FIGS. 14 and 15, the same reference numerals are respectively used for the similar elements as these in the embodiment of FIG. 1.

In this embodiment, as is mentioned, the metal layer 142 is formed above only one surface of the coil conductor 10. This configuration can also shift the peak of the input impedance of the coil conductor 10 to the higher frequency and lower the peak level of the input impedance. This embodiment can certainly provide the same advantages as the embodiment of FIG. 1.

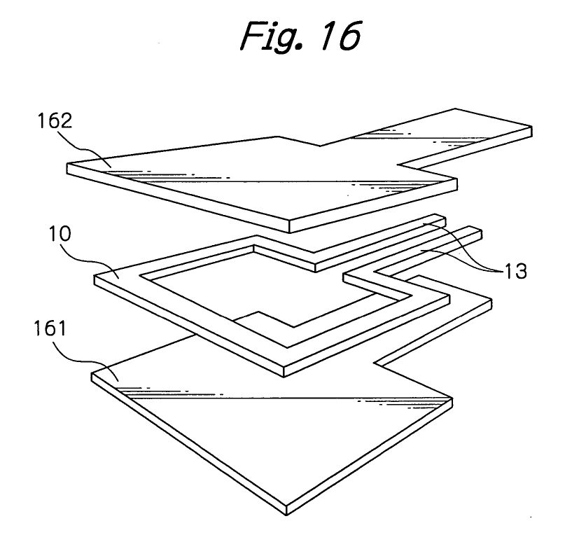

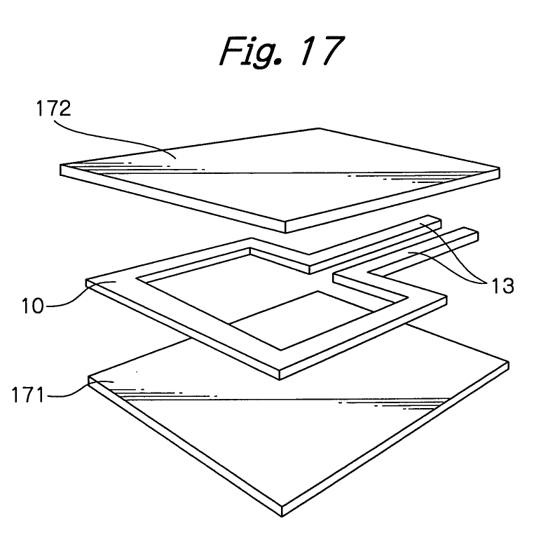

FIG. 16 illustrates a simple configuration of a coil conductor and metal layers of a thin-film magnetic head as a still further embodiment according to the present invention.

In the figure, reference numeral 10 denotes the coil conductor in a write head element of the thin-film magnetic head, 13 denotes trace conductors respectively connected to both ends of the coil conductor 10, and 161 and 162 denote lower and upper metal layers in a shape of two plates closely located below and above the coil conductor 10 and the trace conductors 13 so as to become in parallel with the plane of the coil conductor 10 and the trace conductors 13. In this embodiment, each of the lower and upper metal layers 161 and 162 is formed in two rectangles within areas where the coil conductor 10 and the trace conductors 13 exist, and the lower and upper metal layers 161 and 162 sandwich the conductor 10 and the trace conductors 13.

Another constitution of this embodiment is substantially the same as that of the embodiment of FIG. 1. Therefore, in FIG. 16, the same reference numerals are respectively used for the similar elements as these in the embodiment of FIG. 1. This embodiment can certainly provide the same advantages as the embodiment of FIG. 1.

FIG. 17 illustrates a simple configuration of a coil conductor and metal layers of a thin-film magnetic head as a further embodiment according to the present invention.

In the figure, reference numeral 10 denotes the coil conductor in a write head element of the thin-film magnetic head, 13 denotes trace conductors respectively connected to both ends of the coil conductor 10, and 171 and 172 denote lower and upper metal layers in a shape of two plates closely located below and above the coil conductor 10 and the trace conductors 13 so as to become in parallel with the plane of the coil conductor 10 and the trace conductors 13. In this embodiment, each of the lower and upper metal layers 171 and 172 is formed in a single rectangle to cover areas where the coil conductor 10 and the trace conductors 13 exist, and the lower and upper metal layers 171 and 172 sandwich the conductor 10 and the trace conductors 13.

Another constitution of this embodiment is substantially the same as that of the embodiment of FIG. 1. Therefore, in FIG. 17, the same reference numerals are respectively used for the similar elements as these in the embodiment of FIG. 1. This embodiment can certainly provide the same advantages as the embodiment of FIG. 1.

In the aforementioned embodiments and the modification, the lower and upper metal layers are not grounded. However, these lower and upper metal layers may be grounded through ground trace conductors additionally formed. If these layers are grounded, the input impedance of the coil conductor can be more lowered.

Many widely different embodiments of the present invention may be constructed without departing from the spirit and scope of the present invention. It should be understood that the present invention is not limited to the specific embodiments described in the specification, except as defined in the appended claims.

What is claimed is:

1. A thin-film magnetic head comprising:
an insulation gap;
first and second magnetic poles separated with each other by said insulation gap;
a yoke magnetically connected to said first and second magnetic poles;
at least one coil conductor wound around said yoke by a plurality of turns; and
at least one metal layer arranged near said at least one coil conductor in parallel with a plane of said at least one coil conductor.

2. The thin-film magnetic head as claimed in claim 1, wherein said at least one metal layer comprises a metal layer covering an area within which said at least one coil conductor is formed.

3. The thin-film magnetic head as claimed in claim 1, wherein the head comprises trace conductors electrically connected to said at least one coil conductor, and wherein said at least one metal layer comprises a metal layer covering an area within which said at least one coil conductor and said trace conductors are formed.

4. The thin-film magnetic head as claimed in claim 1, wherein said at least one metal layer is not grounded.

5. The thin-film magnetic head as claimed in claim 1, wherein said at least one metal layer is grounded.

6. The thin-film magnetic head as claimed in claim 1, wherein said at least one metal layer consists of a single metal layer arranged at one side of said at least one coil conductor.

7. The thin-film magnetic head as claimed in claim 1, wherein said at least one metal layer consists of a plurality of metal layers arranged at both sides of said at least one coil conductor.

8. The thin-film magnetic head as claimed in claim 1, wherein the head comprises trace conductors electrically connected to said at least one coil conductor, and wherein said trace conductors are arranged so as to not penetrate said at least one metal layer.

9. The thin-film magnetic head as claimed in claim 1, wherein the head comprises trace conductors electrically connected to said at least one coil conductor, and wherein said trace conductors are arranged so that a part of the trace conductor penetrates said at least one metal layer.

10. The thin-film magnetic head as claimed in claim 1, wherein said at least one coil conductor consists of a single coil conductor.

11. The thin-film magnetic head as claimed in claim 1, wherein said at least one metal layer comprises a metal layer made of a metal material with a high conductivity.
